(19) United States
(12) Patent Application Publication
(10) Pub. No.: US 2026/0071732 A1
(43) Pub. Date: Mar. 12, 2026

(54) VEHICLE LAMP

(71) Applicant: SL Corporation, Daegu (KR)

(72) Inventors: Jeongsu LEE, Gyeongsan-si (KR); Jongwoon KIM, Gyeongsan-si (KR)

(21) Appl. No.: 19/295,629

(22) Filed: Aug. 10, 2025

Related U.S. Application Data
(63) Continuation of application No. PCT/KR2024/001009, filed on Jan. 22, 2024.

(30) Foreign Application Priority Data
Feb. 10, 2023 (KR) 10-2023-0017941

(51) Int. Cl. F21S 41/663; F21S 41/143; F21S 41/25; F21S 41/43; F21S 41/657

(52) U.S. Cl. CPC F21S 41/663; F21S 41/143; F21S 41/25; F21S 41/43; F21S 41/657

(57) ABSTRACT

A vehicle lamp allows to form an image of a predetermined shape by light emitted from at least one lamp module. The at least one lamp module includes a light source unit including a plurality of light sources that generate light; a first lens unit including a plurality of optical path adjustment units that adjust paths of the light respectively generated from the plurality of light sources; and a second lens unit that transmits the light incident from the first lens unit to allow the light to be emitted. The second lens unit includes a plurality of transmission areas through which the light emitted from each of the plurality of optical path adjustment units is transmitted.

### CROSS-REFERENCE TO RELATED APPLICATIONS

This application is a Continuation of International Application No. PCT/KR2024/001009 filed Jan. 22, 2024, which claims priority from Korean Application No. 10-2023-0017941 filed Feb. 10, 2023. The aforementioned applications are incorporated herein by reference in their entireties.

### TECHNICAL FIELD

The present disclosure relates to a vehicle lamp, and more particularly, to a vehicle lamp capable of forming various images while preventing the occurrence of chromatic aberration.

### RELATED ART

In general, vehicles are equipped with various types of lamps that serve an illumination function to allow easier identification of objects located around the vehicles during low-light conditions (e.g., nighttime driving) and a signaling function to inform other vehicles or road users of the driving status of the vehicles.

For example, headlamps and fog lamps are primarily intended for the illumination function, while turn signal lamps, tail lamps, and brake lamps are primarily intended for the signaling function. Such lamps are regulated by law with respect to installation standards and specifications so that each function can be fully achieved.

Since the information capable of being provided through lighting and signaling functions only is limited, research has been actively conducted recently to enable the formation of images such as characters or patterns on road surfaces around the vehicle in addition to the illumination and signaling functions, so as to provide more diverse information to the driver, drivers of surrounding vehicles, pedestrians, and others.

In addition, in a vehicle lamp, the light generated from a light source is emitted through a lens, and the light incident on the lens may experience differences in refractive index depending on its wavelength, which may cause chromatic aberration. Such chromatic aberration tends to become more pronounced toward the outer side of the lens.

Therefore, there is a need for a solution that prevents the light emitted from the vehicle lamp from exhibiting non-uniform color due to chromatic aberration.

### SUMMARY

One object to be achieved by the present disclosure is to provide a vehicle lamp capable of forming images in various shapes through a single optical system.

Another object is to provide a vehicle lamp that blocks light that is highly likely to cause chromatic aberration, thereby allowing the formation of an image with more uniform brightness and color.

The objectives of the present disclosure are not limited to those mentioned above, and other objectives not explicitly stated will be clearly understood by those skilled in the art based on the following description.

According to an aspect of the present disclosure, a vehicle lamp may form an image having a predetermined shape using light emitted from at least one lamp module. The at least one lamp module may include a light source unit including a plurality of light sources that generate light; a first lens unit including a plurality of optical path adjustment units that adjust a path of the light generated from the plurality of light sources, respectively; and a second lens unit that transmit the light incident from the first lens unit to be emitted therethrough. In particular, the second lens unit may include a plurality of transmission areas through which the light emitted from the respective plurality of optical path adjustment units is transmitted.

Adjacent optical path adjustment units among the plurality of optical path adjustment units may be spaced apart at a predetermined interval.

The first lens unit may be coupled to a holder in which a plurality of transmission holes corresponding to the plurality of optical path adjustment units, respectively, are formed, and the holder may include: a partition that divides the plurality of transmission holes; first extension portions that extend from the partition toward the light source unit; and second extension portions that extend from the partition toward the second lens unit. The first lens unit may include through-holes through which ends of the first extension portions pass to extend toward the light source unit.

The second lens unit may include: a light transmission portion; a plurality of incident lenses disposed on an incident surface of the light transmission portion; a plurality of emission lenses disposed on an emission surface of the light transmission portion; and a plurality of shields in which aperture units are formed to allow a portion of light that proceeds toward the respective emission lenses to pass therethrough and block another portion of the light. The plurality of shields may be formed on the incident surface of the light transmission portion.

Focal points of the plurality of incident lenses may be disposed on the emission surface of the light transmission portion, and focal points of the plurality of emission lenses may be disposed on the incident surface of the light transmission portion.

The plurality of incident lenses, the plurality of emission lenses, and the plurality of shields may be disposed within the plurality of transmission areas, and adjacent transmission areas among the plurality of transmission areas may be formed to be spaced apart at a predetermined interval.

The plurality of shields may include a shield included in one of the plurality of transmission areas and a shield included in another of the plurality of transmission areas, and shields included in different transmission areas among the plurality of transmission areas may include aperture units having different configurations.

Shields included in each of the plurality of transmission areas may include aperture units having different configurations depending on positions thereof with reference to a center of a corresponding optical path adjustment unit among the plurality of optical path adjustment units.

The aperture units of shields included in each of the plurality of transmission areas may be formed such that compared to a shield disposed at a center of a corresponding optical path adjustment unit among the plurality of optical path adjustment units, portions of the aperture units are omitted in shields that are disposed radially away from a center of the corresponding optical path adjustment unit.

Each of the plurality of optical path adjustment units may have a size equal to or smaller than a corresponding transmission area among the plurality of transmission areas.

The vehicle lamp may further include a controller that controls at least one of lighting duration, lighting sequence, lighting interval, or lighting brightness of each of the plurality of light sources.

The vehicle lamp may further include a driver that rotates the at least one lamp module in at least one direction to allow a position where the image is formed by the at least one lamp module to be changed.

Other specific details of the present disclosure are included in the detailed description and the drawings.

According to the vehicle lamp of the present disclosure as described above, the following effects may be achieved.

Since the lighting sequence, lighting interval, and lighting time of a plurality of light sources can be controlled, not only static images but also dynamic images such as animation effects can be achieved, thereby enabling the formation of images in more diverse shapes.

Additionally, since light with a high likelihood of chromatic aberration is blocked, it is also possible to form an image with more uniform brightness and color.

It should be noted that the effects of the present disclosure are not limited to those described above, and other effects of the present disclosure will be apparent from the following description.

### BRIEF DESCRIPTION OF THE DRAWINGS

FIG. 1 is a block diagram illustrating the configuration of a vehicle lamp according to an embodiment of the present disclosure.

FIG. 2 is a perspective view illustrating a lamp module according to an embodiment of the present disclosure.

FIGS. 3 and 4 are exploded perspective views illustrating the lamp module according to an embodiment of the present disclosure.

FIG. 5 is a side view illustrating the lamp module according to an embodiment of the present disclosure.

FIGS. 6 and 7 are exploded perspective views illustrating a second lens unit according to an embodiment of the present disclosure.

FIG. 8 is a front view illustrating the second lens unit according to an embodiment of the present disclosure.

FIG. 9 is a rear view illustrating the second lens unit according to an embodiment of the present disclosure.

FIG. 10 is a rear view illustrating a light transmission part with a plurality of shields formed therein according to an embodiment of the present disclosure.

FIG. 11 is a schematic view illustrating the focal points of a plurality of incident lenses and their respective emission lenses among a plurality of emission lenses according to an embodiment of the present disclosure.

FIG. 12 is a rear view illustrating a plurality of shields included in a plurality of transmission areas according to an embodiment of the present disclosure.

FIG. 13 is a schematic view illustrating the aperture unit shapes of shields at different positions from the center of an optical path adjustment units according to an embodiment of the present disclosure.

### DETAILED DESCRIPTION

The advantages and features of the present disclosure, and methods for achieving them, will become apparent with reference to the embodiments to be described in detail below in conjunction with the accompanying drawings. However, the present disclosure is not limited to those embodiments, but may be implemented in various different forms. The embodiments are merely provided to fully disclose the scope of the present disclosure and to completely inform those skilled in the art of the scope of the disclosure, and the present disclosure is defined only by the scope of the claims. Throughout the specification, like reference numerals refer to like elements.

Accordingly, in some embodiments, well-known process steps, structures, and technologies are not described in detail in order to avoid ambiguous interpretation of the present disclosure.

The terminology used in this specification is intended to describe the embodiments and is not intended to limit the scope of the present disclosure. As used herein, the singular forms include plural forms as well unless explicitly stated otherwise. The terms “comprises” and/or “comprising,” as used herein, specify the presence of stated components, steps, operations, and/or elements but do not preclude the presence or addition of one or more other components, steps, operations, and/or elements. The term “and/or” includes each and all possible combinations of one or more of the associated listed items.

In addition, the embodiments disclosed in this specification will be described with reference to cross-sectional views and/or schematic views, which are ideal exemplary illustrations of the present disclosure. Therefore, modifications to the illustrated forms may occur due to manufacturing techniques and/or tolerances. Accordingly, the embodiments of the present disclosure are not limited to the specific forms depicted but include variations in shape resulting from the manufacturing processes. Also, in the drawings of the present disclosure, elements may be illustrated as being enlarged or reduced for convenience of description. Like reference numerals refer to like elements throughout the specification.

The present disclosure will hereinafter be described with reference to the accompanying drawings for explaining vehicle lamps according to embodiments of the present disclosure.

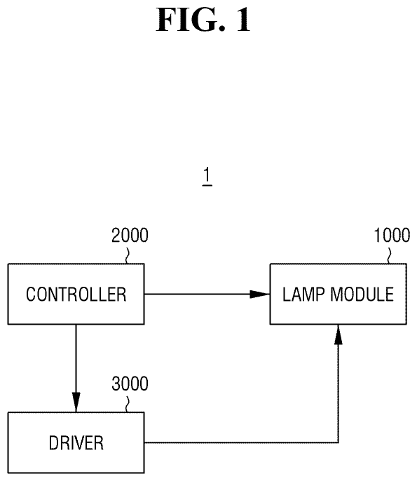

FIG. 1 is a block diagram illustrating the configuration of a vehicle lamp according to an embodiment of the present disclosure. Referring to FIG. 1, a vehicle lamp 1 according to an embodiment of the present disclosure may include a lamp module 1000, a controller 2000, and a driver 3000.

In this embodiment of the present disclosure, the vehicle lamp 1 is described, by way of example, as functioning to form an image that represents various types of information to be communicated to the driver, surrounding vehicles, or pedestrians on a road surface around the vehicle. However, the present disclosure is not limited thereto, and the vehicle lamp 1 of the present disclosure may be used for various lamps installed in the vehicle for illumination or signaling purposes.

For example, the vehicle lamp 1 of the present disclosure may form an image on the road surface around the vehicle to implement a welcoming function that makes the vehicle appear to greet the driver when the driver approaches the vehicle. Alternatively, the vehicle lamp 1 of the present disclosure may form an image on the road surface around the vehicle to inform surrounding vehicles or pedestrians of the vehicle's status, such as the vehicle's driving direction or door opening.

When the vehicle lamp 1 of the present disclosure is used to form an image on the road surface around the vehicle, it may be installed in various positions, such as an outside mirror, rocker panel, front portion of the body of the vehicle, or rear portion of the body of the vehicle. However, these examples are merely illustrative for understanding the present disclosure and are not limiting. The position at which the vehicle lamp 1 of the present disclosure is installed may vary, as long as it allows the light to be irradiated onto the road surface around the vehicle without interference.

The lamp module 1000 may serve to irradiate light for forming an image on the road surface around the vehicle, and at least one lamp module 1000 may be installed depending on the size, shape, or position of the image to be formed on the road surface around the vehicle.

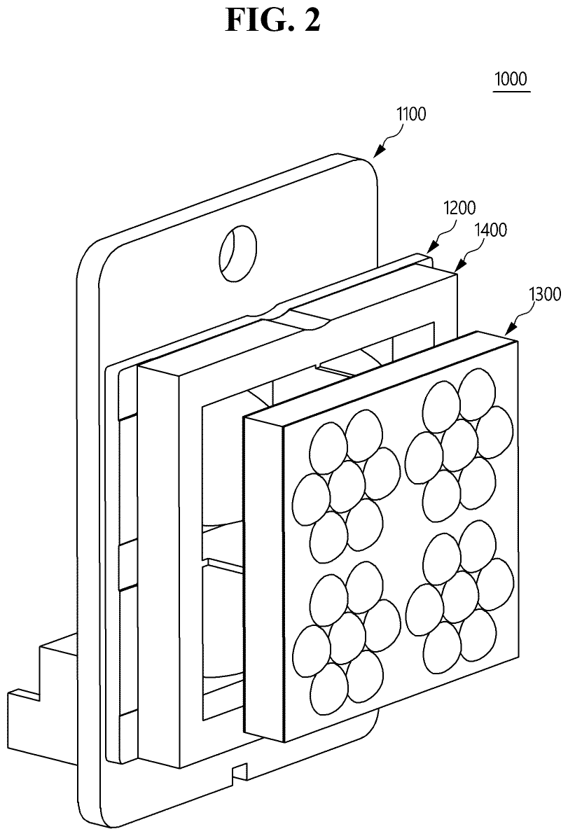

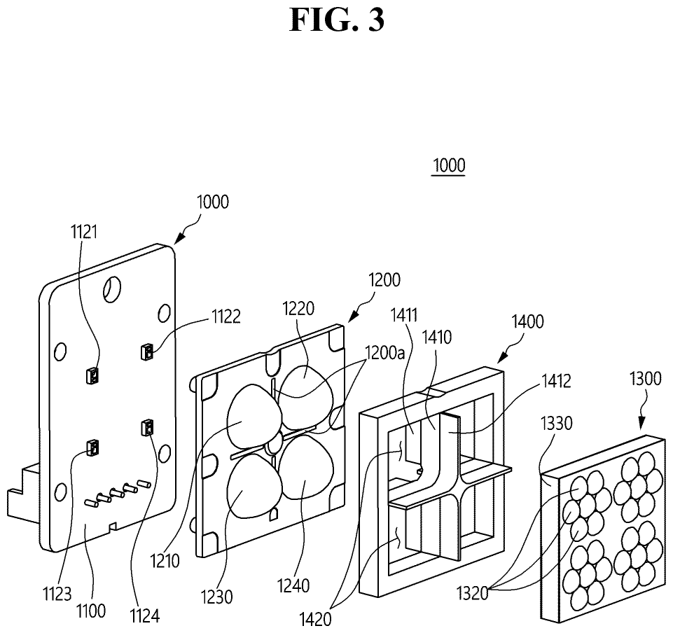

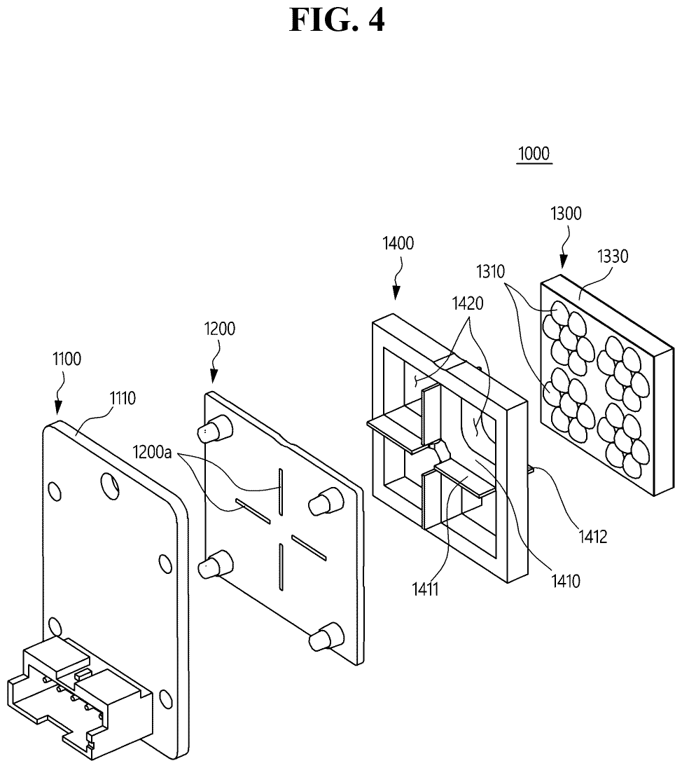

FIG. 2 is a perspective view illustrating a lamp module according to an embodiment of the present disclosure, and FIGS. 3 and 4 are exploded perspective views illustrating the lamp module according to an embodiment of the present disclosure.

Referring to FIGS. 2 through 4, a lamp module 1000 according to an embodiment of the present disclosure may include a light source unit 1100, a first lens unit 1200, and a second lens unit 1300.

The light source unit 1100 may include a substrate 1110 and a plurality of light sources 1121, 1122, 1123, and 1124 installed on the substrate 1110. In this embodiment of the present disclosure, the plurality of light sources 1121, 1122, 1123, and 1124 will hereinafter be referred to respectively as a first light source 1121, a second light source 1122, a third light source 1123, and a fourth light source 1124.

In this embodiment of the present disclosure, the light source unit 1100 may include the plurality of light sources 1121, 1122, 1123, and 1124 to allow the controller 2000 to control the lighting sequence, lighting interval, and lighting duration of each of the plurality of light sources 1121, 1122, 1123, and 1124 and thereby enable the implementation of dynamic images such as animation effects rather than static images. This will be described later in further detail.

In addition, in this embodiment of the present disclosure, the inclusion of four light sources 1121, 1122, 1123, and 1124 in the light source unit 1100 is merely illustrative for understanding the present disclosure, and the present disclosure is not limited thereto. The number of light sources included in the light source unit 1100 may vary depending on the number of images to be formed by the lamp module 1000 of the present disclosure.

The first lens unit 1200 may be disposed in front of the light source unit 1100 and may serve to adjust the path of the light so that the light generated from the light source unit 1100 is incident on the second lens unit 1300, which is disposed in front of the first lens unit 1200, with minimal loss.

In this case, the plurality of light sources 1121, 1122, 1123, and 1124 may be disposed such that their emission surfaces face forward, so that the light from the plurality of light sources 1121, 1122, 1123, and 1124 is incident on the first lens unit 1200 disposed in front of the light source unit 1100.

The first lens unit 1200 may be disposed in front of the light source unit 1100, and the second lens unit 1300 may be disposed in front of the first lens unit 1200. This arrangement is based on an assumption that the light-irradiation direction of the lamp module 1000 of the present disclosure is forward. However, the actual direction referred to as “forward” may vary depending on the position and/or orientation in which the lamp module 1000 of the present disclosure is installed.

The first lens unit 1200 may include a plurality of optical path adjustment units 1210, 1220, 1230, and 1240 corresponding to the plurality of light sources 1121, 1122, 1123, and 1124, respectively. In this embodiment of the present disclosure, since the light source unit 1100 is described as including the first, second, third, and fourth light sources 1121, 1122, 1123, and 1124, the plurality of optical path adjustment units 1210, 1220, 1230, and 1240 are described, by way of example, as including first, second, third, and fourth optical path adjustment units 1210, 1220, 1230, and 1240 corresponding to the first, second, third, and fourth light sources 1121, 1122, 1123, and 1124, respectively. However, the present disclosure is not limited thereto, and the number of optical path adjustment units may vary depending on the number of light sources.

In this embodiment of the present disclosure, aspheric lenses that convert the light incident from the plurality of light sources 1121, 1122, 1123, and 1124 into collimated light are described, by way of example, as being used as the plurality of optical path adjustment units 1210, 1220, 1230, and 1240, but the present disclosure is not limited thereto. In addition to aspheric lenses, other various types of lenses capable of adjusting the light path, such as total internal reflection (TIR) lenses or Fresnel lenses may be used as the optical path adjustment units 1210, 1220, 1230, and 1240.

The plurality of optical path adjustment units 1210, 1220, 1230, and 1240 may be formed integrally with one another, but adjacent optical path adjustment units among the plurality of optical path adjustment units 1210, 1220, 1230, and 1240 may be spaced apart at a predetermined interval. In this embodiment of the present disclosure, adjacent optical path adjustment units among the plurality of optical path adjustment units 1210, 1220, 1230, and 1240 may be spaced apart at the predetermined interval to prevent interference when different images are to be formed by beams of light generated from the plurality of light sources 1121, 1122, 1123, and 1124.

Meanwhile, the first lens unit 1200 may be coupled to a holder 1400 in which a partition 1410 is formed so that the beams of light generated from the plurality of light sources 1121, 1122, 1123, and 1124 pass through the plurality of optical path adjustment units 1210, 1220, 1230, and 1240, respectively, and reach the second lens unit 1300 without interference. The partition 1410 may be formed to extend along the spaces between adjacent optical path adjustment units among the plurality of optical path adjustment units 1210, 1220, 1230, and 1240, and may define a plurality of transmission holes 1420 corresponding to the plurality of optical path adjustment units 1210, 1220, 1230, and 1240, respectively.

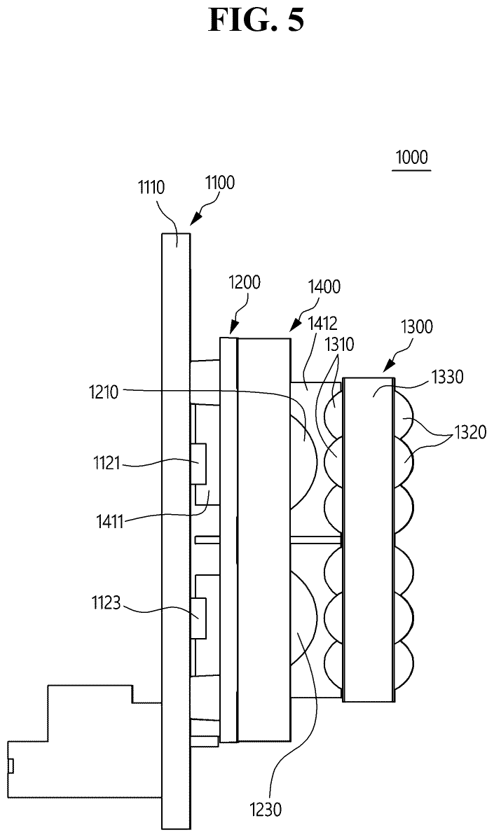

The partition 1410 may include first extension portions 1411 that extend toward the light source unit 1100 and second extension portions 1412 that extend toward the second lens unit 1300. As illustrated in FIG. 5, the ends (e.g. proximal ends) of the first extension portions 1411 may be formed to extend toward the substrate 1110 by passing through through-holes 1200a formed between adjacent optical path adjustment units among the plurality of optical path adjustment units 1210, 1220, 1230, and 1240 in the first lens unit 1200.

In this case, the ends of the first extension portions 1411 may be disposed to be adjacent to or in contact with the substrate 1110, and the ends of the second extension portions 1412 may be disposed to be adjacent to or in contact with the second lens unit 1300. Accordingly, the light source unit 1100, the first lens unit 1200, and the second lens unit 1300 may maintain appropriate spacing from one another while allowing the light generated from each of the plurality of light sources 1121, 1122, 1123, and 1124 to proceed without interference.

The second lens unit 1300 may serve to transmit the light emitted from the first lens unit 1200 therethrough to allow an image to be formed on the road surface around the vehicle.

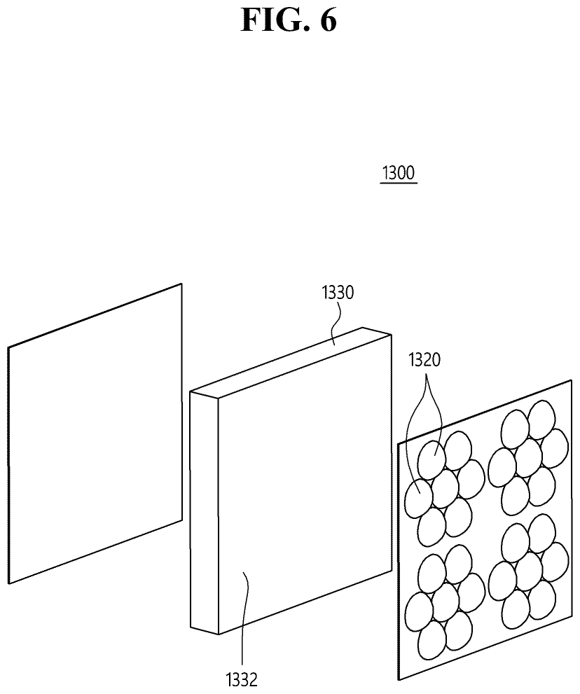

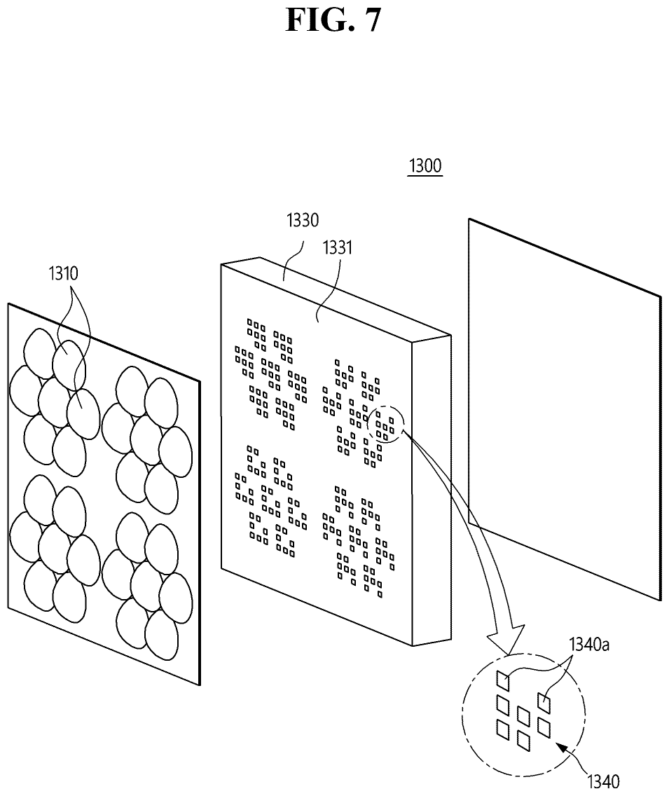

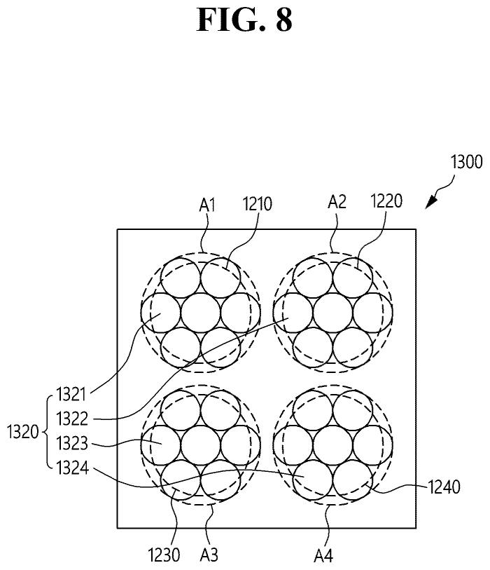

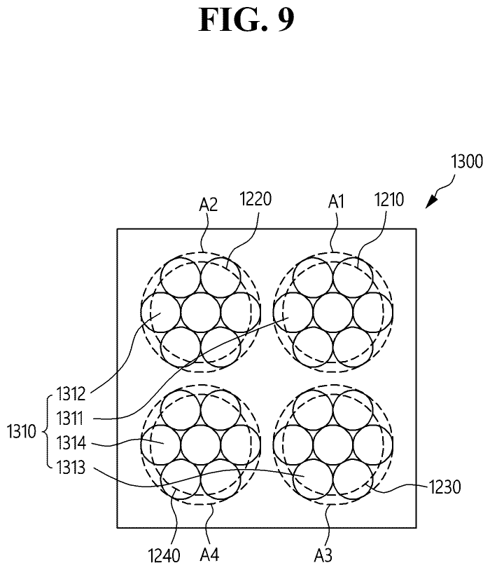

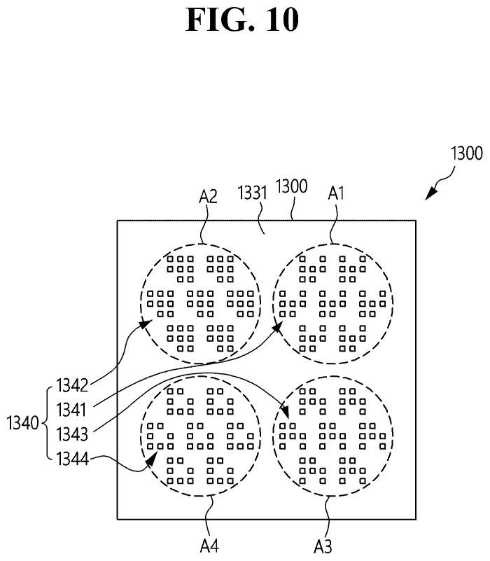

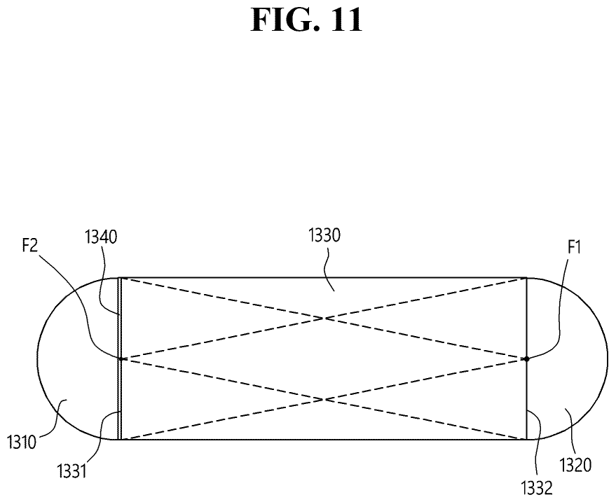

FIGS. 6 and 7 are exploded perspective views illustrating a second lens unit according to an embodiment of the present disclosure, FIG. 8 is a front view illustrating the second lens unit according to an embodiment of the present disclosure, FIG. 9 is a rear view illustrating the second lens unit according to an embodiment of the present disclosure, FIG. 10 is a rear view illustrating a light transmission portion with a plurality of shields formed therein according to an embodiment of the present disclosure, and FIG. 11 is a schematic view illustrating the focal points of a plurality of incident lenses and their respective emission lenses among a plurality of emission lenses according to an embodiment of the present disclosure.

Referring to FIGS. 6 through 11, a second lens unit 1300 according to an embodiment of the present disclosure may include a plurality of incident lenses 1310, a plurality of emission lenses 1320, a light transmission portion 1330, and a plurality of shields 1340.

The plurality of incident lenses 1310 may receive light from the first lens unit 1200, and beams of light incident on the plurality of incident lenses 1310 may be emitted through the respective emission lenses 1320. In this embodiment of the present disclosure, the plurality of incident lenses 1310 and the plurality of emission lenses 1320 are described, by way of example, as being micro lenses, which are advantageous for miniaturization due to their relatively short focal lengths.

The plurality of incident lenses 1310 and the plurality of emission lenses 1320 may be disposed on an incident surface 1331 and an emission surface 1332, respectively, of the light transmission portion 1330. The light transmission portion 1330 may be formed of a material such as glass, through which light is capable of being transmitted, so that the beams of light incident on the plurality of incident lenses 1310 may be emitted through the respective emission lenses 1320 via the light transmission portion 1330.

The plurality of shields 1340 may serve to allow some of the light that proceeds toward the respective emission lenses 1320 to pass through and to block some of the light, depending on the shape of the image to be formed around the vehicle.

In this embodiment of the present disclosure, by way of example, each of the plurality of shields 1340 may include an aperture unit including a plurality of aperture holes 1340a, through which light passes, is described. The position, number, shape, and size of the aperture holes 1340a may vary depending on the shape of the image to be formed by the lamp module 1000 of the present disclosure.

In this embodiment of the present disclosure, the aperture unit is described, by way of example, as including a plurality of aperture holes 1340a, but the present disclosure is not limited thereto. Alternatively, the aperture unit may include a single aperture hole, depending on the image to be formed by the lamp module 1000 of the present disclosure.

The plurality of shields 1340 may be formed on the incident surface 1331 of the light transmission portion 1330 by a process such as coating or deposition. Among the plurality of shields 1340, adjacent shields may be formed integrally or separately.

As shown in FIG. 11, each of the plurality of incident lenses 1310 may have a focal point F1 disposed on the emission surface 1332 of the light transmission portion 1330, and each of the plurality of emission lenses 1320 may have a focal point F2 disposed on the incident surface 1331 of the light transmission portion 1330.

In this embodiment of the present disclosure, the plurality of shields 1340 may be formed on the incident surface 1331 of the light transmission portion 1330 such that they are disposed at or near the focal points F2 of the respective emission lenses 1320. In this case, since the focal lengths of the plurality of emission lenses 1320 may become relatively longer, it is possible to prevent the light emitted from the plurality of emission lenses 1320 from proceeding in unnecessary directions and to prevent the occurrence of chromatic aberration while maintaining uniform brightness.

That is, the shorter the focal lengths of the plurality of emission lenses 1320, the greater the refraction angle required to direct the light emitted from the plurality of emission lenses 1320 forward. In such a case, the plurality of emission lenses 1320 are required to have a greater curvature, and as a result, the light emitted from the plurality of emission lenses 1320 may proceed in unnecessary directions, causing glare or chromatic aberration. Therefore, the focal points F2 of the plurality of emission lenses 1320 may be disposed on the incident surface 1331 of the light transmission portion 1330 to increase the focal lengths of the plurality of emission lenses 1320, thereby allowing the plurality of emission lenses 1320 to have relatively small curvature.

Similarly, the plurality of incident lenses 1310 may also be configured such that their focal points F1 are disposed on the emission surface 1332 of the light transmission portion 1330 so as to have relatively longer focal lengths, thereby preventing glare or chromatic aberration and ensuring more uniform brightness, similar to the plurality of emission lenses 1320.

Meanwhile, referring to FIGS. 8 and 9, the second lens unit 1300 may be divided into a plurality of transmission areas A1, A2, A3, and A4. The plurality of transmission areas A1, A2, A3, and A4 may serve to transmit at least a portion of the light generated from the plurality of light sources 1121, 1122, 1123, and 1124, respectively. Similar to the plurality of optical path adjustment units 1210, 1220, 1230, and 1240, adjacent transmission areas among the plurality of transmission areas A1, A2, A3, and A4 may be spaced apart at a predetermined interval, and the ends (e.g., distal ends) of the second extension portions 1412 of the holder 1400 described above may be disposed to abut the regions between adjacent transmission areas among the plurality of transmission areas A1, A2, A3, and A4.

The plurality of transmission areas A1, A2, A3, and A4 may be understood as regions that respectively contact the plurality of emission lenses 1320 belonging to the plurality of transmission areas A1, A2, A3, and A4. The plurality of optical path adjustment units 1210, 1220, 1230, and 1240 may be disposed within the plurality of transmission areas A1, A2, A3, and A4, respectively, as illustrated in FIGS. 8 and 9, and may have a smaller size than the respective transmission areas. However, the present disclosure is not limited thereto, and the plurality of optical path adjustment units 1210, 1220, 1230, and 1240 may also have an equal size as the respective transmission areas.

For example, when the plurality of optical path adjustment units 1210, 1220, 1230, and 1240 and the plurality of transmission areas A1, A2, A3, and A4 are disposed such that the centers of the plurality of optical path adjustment units coincide with the centers of the respective transmission areas, the radius of the optical path adjustment units 1210, 1220, 1230, and 1240 may be formed to be equal to or smaller than the radius of the plurality of transmission areas A1, A2, A3, and A4. Here, the plurality of optical path adjustment units 1210, 1220, 1230, and 1240 may be formed to have a size equal to or smaller than that of the respective transmission areas to ensure that the light emitted from the plurality of optical path adjustment units is incident on the respective transmission areas without loss, thereby improving light efficiency.

In other words, if the plurality of optical path adjustment units 1210, 1220, 1230, and 1240 are larger than the respective transmission areas, some of the light emitted from the outer portions of the plurality of optical path adjustment units 1210, 1220, 1230, and 1240 may not be incident on the respective transmission areas, resulting in light loss. However, In this embodiment of the present disclosure, since the plurality of optical path adjustment units 1210, 1220, 1230, and 1240 have a size equal to or smaller than that of the respective transmission areas, the light emitted from the plurality of optical path adjustment units 1210, 1220, 1230, and 1240 may be incident on the respective transmission areas without loss.

When the second lens unit 1300 is divided into the plurality of transmission areas A1, A2, A3, and A4, the plurality of incident lenses 1310, the plurality of emission lenses 1320, and the plurality of shields 1340 may be included in the respective transmission areas. In this case, no incident lenses, emission lenses, and shields may be formed between adjacent transmission areas among the plurality of transmission areas A1, A2, A3, and A4.

In this embodiment of the present disclosure, since the light source unit 1100 includes four light sources 1121, 1122, 1123, and 1124, the second lens unit 1300 is described, by way of example, as including four transmission areas A1, A2, A3, and A4. In this embodiment of the present disclosure, the plurality of transmission areas A1, A2, A3, and A4 will hereinafter be referred to as first, second, third, and fourth transmission areas A1, A2, A3, and A4.

In this case, when the second lens unit 1300 includes the first, second, third, and fourth transmission areas A1, A2, A3, and A4, the plurality of incident lenses 1310 may include first, second, third, and fourth incident lenses 1311, 1312, 1313, and 1314, which are included in the first, second, third, and fourth transmission areas A1, A2, A3, and A4, respectively.

In addition, similar to the plurality of incident lenses 1310, the plurality of emission lenses 1320 may include first, second, third, and fourth emission lenses 1321, 1322, 1323, and 1324 included in the first, second, third, and fourth transmission areas A1, A2, A3, and A4, respectively. Similarly, the plurality of shields 1340 may include first shields 1341, second shields 1342, third shields 1343, and fourth shields 1344 included in the first, second, third, and fourth transmission areas A1, A2, A3, and A4, respectively.

As illustrated in FIG. 10, the first, second, third, and fourth transmission areas A1, A2, A3, and A4 may include shields having different configurations. This feature may allow an image formed by the light transmitted through one transmission area to have a different shape from an image formed by the light transmitted through another transmission area, thereby enabling the formation of images in more diverse shapes.

FIG. 10 illustrates an example in which the first shields 1341, the second shields 1342, the third shields 1343, and the fourth shields 1344 all have different shapes from one another, but the present disclosure is not limited thereto. At least of the first shields 1341, second shields 1342, third shields 1343, or fourth shields 1344 may have a different shape from at least another.

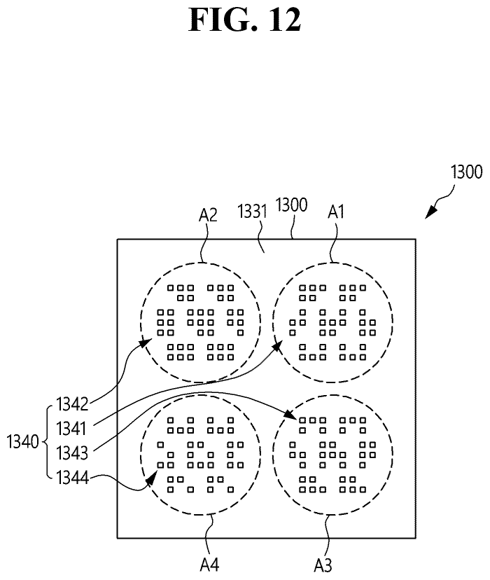

In addition, at least one of the first, second, third, or fourth transmission areas A1, A2, A3, and A4 may have shields whose shape varies depending on their position, as illustrated in FIG. 12. The shape variation of the shields may refer to changes in at least one of the position, number, shape, or size of the aperture holes 1340a described above.

In other words, the closer the light emitted from the plurality of optical path adjustment units 1210, 1220, 1230, and 1240 is to the outer sides (e.g., peripheral edges) of the plurality of optical path adjustment units 1210, 1220, 1230, and 1240, the higher the probability of chromatic aberration. Therefore, the shields included in each of the plurality of transmission areas A1, A2, A3, and A4 may have different shapes depending on whether the shields are disposed at or spaced radially from the center of the corresponding optical path adjustment units.

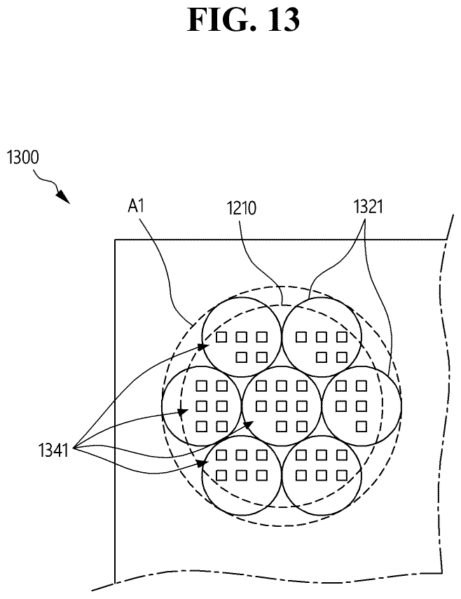

For example, as illustrated in FIG. 13, among a plurality of first shields 1341, a first shield spaced radially outward from the center of the first optical path adjustment units 1210 may include some aperture holes omitted in the radially outward direction, compared to the shape of another first shield disposed at the center of the first optical path adjustment units 1210. As described above, this structure may block light that has a high likelihood of chromatic aberration, because the probability of chromatic aberration increases for light emitted through the outer side relative to the center of the first optical path adjustment units 1210.

Here, FIG. 13 illustrates an example of the plurality of first shields 1341 as viewed from the front of the second lens unit 1300. Specifically, in the example shown in FIG. 13, the shape of the first shield disposed at the center of the first optical path adjustment units 1210 among the plurality of first shields 1341 serves as the basis for other first shields around it. First shields disposed above the central first shield have some aperture holes omitted on its upper side, first shields disposed below the central first shield have some aperture holes omitted on its lower side, and first shields disposed at the left and right sides of the central first shield each have some aperture holes omitted on its left and right sides, respectively.

In this embodiment of the present disclosure, the aperture holes are described, by way of example, as being omitted on the upper, lower, left, or right side of a first shield depending on the position of the first shield, but the present disclosure is not limited thereto. Alternatively, the aperture holes may be omitted on a diagonal side depending on the position of the first shield.

Also, FIG. 13 illustrates the first transmission area A1 as an example, but the description in FIG. 13 may be similarly applicable to the second shields 1342, the third shields 1343, and the fourth shields 1344 included in the second, third, and fourth transmission areas A2, A3, and A4, respectively.

The controller 2000 may control the lighting duration, lighting sequence, lighting interval, lighting brightness, and the like of each of the plurality of light sources 1121, 1122, 1123, and 1124, thereby allowing the lamp module 1000 of the present disclosure to form not only static images but also dynamic images.

For example, the controller 2000 may cause each of the first, second, third, and fourth light sources 1121, 1122, 1123, and 1124 to be turned on for a preset period of time in a preset order. Alternatively, the controller 2000 may cause two or more of the first, second, third, and fourth light sources 1121, 1122, 1123, and 1124 to be turned on simultaneously for a preset period of time in a preset order. Additionally, the controller 2000 may cause one of the first, second, third, or fourth light sources 1121, 1122, 1123, and 1124 to be turned on at a lighting brightness different from another.

In this case, images formed by turning on the plurality of light sources 1121, 1122, 1123, and 1124 may have individually different shapes, or two or more such images may be combined to form a single shape.

In some embodiments, the driver 3000 may rotate the lamp module 1000 in at least one direction, thereby changing the position where images are formed.

For example, when the user (e.g., operator, driver, and passenger) approaches the vehicle, the controller 2000 may control the driver 3000 to allow the lamp module 1000 to rotate in at least one direction such that the position at which an image for a welcoming function is formed differs from the position at which an image is formed to inform surrounding vehicles or pedestrians that the vehicle door is opening.

As described above, according to the vehicle lamp 1 of the present disclosure, it is possible to form more diverse images by allowing some of the plurality of shields 1340 to have aperture units having different configurations. It is also possible to block light with a high likelihood of causing chromatic aberration among the beams of light emitted from the plurality of optical path adjustment units 1210, 1220, 1230, and 1240, thereby preventing or reducing chromatic aberration from occurring.

Those skilled in the art will understand that the present disclosure may be implemented in other specific forms without changing the technical spirit or essential features. Therefore, the above-described embodiments should be understood as illustrative in all aspects and not as limiting. The scope of the present disclosure should be indicated by the claims described below rather than the foregoing detailed description, and all modifications or variations derived from the meaning and scope of the claims and their equivalents should be construed as being included in the scope of the present disclosure.

What is claimed is:

1. A vehicle lamp configured to form an image of a predetermined shape by light emitted from at least one lamp module,
wherein the at least one lamp module includes:
a light source unit including a plurality of light sources that generate light;
a first lens unit including a plurality of optical path adjustment units that adjust a path of the light generated from the plurality of light sources, respectively; and
a second lens unit that transmit the light incident from the first lens unit to be emitted therethrough, and
wherein the second lens unit includes a plurality of transmission areas through which the light emitted from the respective plurality of optical path adjustment units is transmitted.

2. The vehicle lamp of claim 1, wherein adjacent optical path adjustment units among the plurality of optical path adjustment units are spaced apart at a predetermined interval.

3. The vehicle lamp of claim 1, wherein the first lens unit is coupled to a holder in which a plurality of transmission holes corresponding to the plurality of optical path adjustment units, respectively, are formed, and
wherein the holder includes:
a partition that divides the plurality of transmission holes;
first extension portions that extend from the partition toward the light source unit; and
second extension portions that extend from the partition toward the second lens unit.

4. The vehicle lamp of claim 3, wherein the first lens unit includes through-holes through which ends of the first extension portions pass to extend toward the light source unit.

5. The vehicle lamp of claim 1, wherein the second lens unit includes:
a light transmission portion;
a plurality of incident lenses disposed on an incident surface of the light transmission portion;
a plurality of emission lenses disposed on an emission surface of the light transmission portion; and
a plurality of shields in which aperture units are formed to allow a portion of light that proceeds toward the respective emission lenses to pass therethrough and block another portion of the light.

6. The vehicle lamp of claim 5, wherein the plurality of shields are formed on the incident surface of the light transmission portion.

7. The vehicle lamp of claim 5, wherein focal points of the plurality of incident lenses are disposed on the emission surface of the light transmission portion, and
wherein focal points of the plurality of emission lenses are disposed on the incident surface of the light transmission portion.

8. The vehicle lamp of claim 5, wherein the plurality of incident lenses, the plurality of emission lenses, and the plurality of shields are disposed within the plurality of transmission areas, and
wherein adjacent transmission areas among the plurality of transmission areas are formed to be spaced apart at a predetermined interval.

9. The vehicle lamp of claim 5, wherein the plurality of shields include a shield included in one of the plurality of transmission areas and a shield included in another of the plurality of transmission areas, and
wherein shields included in different transmission areas among the plurality of transmission areas include aperture units having different configurations.

10. The vehicle lamp of claim 5, wherein shields included in each of the plurality of transmission areas include aperture units having different configurations depending on positions thereof with reference to a center of a corresponding optical path adjustment unit among the plurality of optical path adjustment units.

11. The vehicle lamp of claim 5, wherein the aperture units of shields included in each of the plurality of transmission areas are formed such that compared to a shield disposed at a center of a corresponding optical path adjustment unit among the plurality of optical path adjustment units, portions of the aperture units are omitted in shields that are disposed radially away from a center of the corresponding optical path adjustment unit.

12. The vehicle lamp of claim 1, wherein each of the plurality of optical path adjustment units has a size equal to or smaller than a corresponding transmission area among the plurality of transmission areas.

13. The vehicle lamp of claim 1, further comprising:
a controller that controls at least one of lighting duration, lighting sequence, lighting interval, or lighting brightness of each of the plurality of light sources.

14. The vehicle lamp of claim 1, further comprising:
a driver that rotates the at least one lamp module in at least one direction to allow a position where the image is formed to be changed.
